(19) United States
(12) Patent Application Publication
(10) Pub. No.: US 2014/0263090 A1
(43) Pub. Date: Sep. 18, 2014

(54) High Flow Rate Fluid Disinfection System

(71) Applicant: Stephen A. Yencho, Menlo Park, CA (US)

(72) Inventor: Stephen A. Yencho, Menlo Park, CA (US)

(21) Appl. No.: 13/841,275

(22) Filed: Mar. 15, 2013

(51) Int. Cl. C02F 1/32

(52) U.S. Cl. CPC C02F 1/325; C02F 1/32
USPC 210/748.11; 250/438

(57) ABSTRACT

One example of a fluid disinfection unit includes a chamber through which fluid can flow, the chamber having an inlet through which fluid enters the chamber and an outlet through which fluid exits the chamber; a source for illuminating the chamber with ultraviolet light; and a plurality of baffles within the chamber for defining a multiplicity of subchambers within the chamber through which fluid to be purified flows from the inlet to the outlet; each subchamber being located to receive the ultraviolet light; where holes are defined through at least one baffle, and wherein those holes collectively define a fluid flow area that increases with the radial distance from the center of the baffle.

### FIELD OF THE INVENTION

The invention generally relates to fluid disinfection, and more specifically to disinfection of water for hydrocarbon fracing.

### BACKGROUND

Modern hydraulic fracturing technology (“fracing”) has made possible the economical extraction of gas and other hydrocarbons trapped in shale. Hydraulic fracturing is increasingly used for well stimulation of horizontally drilled oil & gas wells, requiring large quantities of water to be pumped down the well at high flow rates. The energy from the injection of a highly pressurized hydraulic fracturing fluid, usually including a significant amount of proppant such as sand suspended therein, creates new channels in the shale, which can increase the extraction rates and ultimate recovery of hydrocarbons. A fluid flow rate of 100 barrels per minute—that is, 4200 gallons (15,900 liters) per minute—may be required in order to perform fracing operations. This flow rate is equivalent to 189,000 gallons per hour, which is greater than typically envisioned for a village-sized or even a municipal-sized water disinfecting unit in many jurisdictions.

Bacteria in the fresh water and the produced water used for fracing need to be killed or inactivated to prevent souring of the well and/or corrosion of the carbon steel well pipe. Due to the high flow rate of fracing fluid, that fluid heats up, which causes bacteria and mold to multiply. Bacteria may also grow when water is kept in open ponds and tanks, especially in warm regions. “Souring” occurs when bacteria grow within the hydrocarbon-rich environment of the well, and has occurred when increasing quantities of hydrogen sulfide (H2S) are observed in production fluids. Hydrogen sulfide may be toxic to workers at the drill site, and causes corrosion of the well pipe. Further, bacteria may inhibit the flow of gas from the well, which is known as plugging. In addition, bacteria can break down the gelling agent that surrounds the proppant, reducing its viscosity and therefore its ability to suspend the proppant. Consequently, fracing water is treated prior to injection into the well to kill most or all bacteria in the water, in order to prevent that water from introducing bacteria into the well that will cause souring. Current technologies for treating fracing water to kill bacteria include chemical biocides such as glutaraldehyde, THPS, DBNA, Dazomet, bromopol, and less toxic or “green” biocides, and oxidizers such as chlorine, chlorine dioxide and ozone. Effective biocides are by definition highly toxic, and require careful handling and disposal of large quantities of water treated with those biocides. Substances in the water such as hydrogen sulfide, iron sulfide, ammonia, and dissolved oxygen may inhibit biocide effectiveness. Indeed, the biocides are a primary driver for public opposition to fracing technology. Alternately, fracing can be performed with waterless methods such as liquefied-propane-based well stimulation, which eliminates the need for water or water treatment, but which is more expensive and potentially hazardous.

Oxidizers, while highly effective at killing bacteria, may have hazardous precursors, potentially exposing field personnel to risks of explosion or ingestion of toxic vapors. Oxidizers such as chlorine and possibly chlorine dioxide have the disadvantage that they are pH dependent, limiting the range of water they can treat. Some oxidizers have the further disadvantage that they require reactions to occur in tanks onsite, occupying more of the limited area available. Since ozone has limited solubility in water, it is possible for toxic concentrations of ozone gas to collect in the space above the water in closed frac tanks, presenting another hazard to field personnel. Oxidizers such as chlorine dioxide and chlorine and some biocides may interfere with, break down, or crosslink chemicals used in the hydraulic fracturing process such as guar and friction reducers. The present invention does not interfere with the fracing chemicals. Systems for treating well stimulation fluids with UVC light are currently commercially available. However, these systems are limited in application because they cannot effectively treat turbid water. Typically, a 99.99% or greater bacteria kill rate is required for well stimulation applications even with turbid waters. (Turbidity is the cloudiness or haziness of a fluid caused by individual particles (suspended solids) that are generally invisible to the naked eye, and often results from suspended solids or from the growth of algae.) A high rate of bacterial inactivation of the water is needed in order to prevent degradation of the well over time due to corrosion of the carbon steel well pipe or the production of hydrogen sulfide.

### SUMMARY OF THE INVENTION

In accordance with the present invention, an enhanced apparatus and method of fluid purification is described, using ultraviolet C (UVC) light which illuminates the fluid in one or more chambers with a centrally located medium pressure ultraviolet lamp. The ultraviolet light breaks the guanine-cytosine bond in the DNA of the bacteria. The broken bond will bond to its nearest available bond, creating a dimer on the DNA strand, preventing the bacterium from replicating. UVC light from medium pressure ultraviolet lamps has been proven to prevent photoreactivation of the inactivated bacteria in the treated water in response to sunlight exposure after processing.

The apparatus and method according to the present invention has demonstrated >99.999993% bacterial inactivation in laboratory testing, as well as high bacteria kill rates during tests on both turbid fresh water and turbid produced water from the Anadarko Basin, Permian Basin and Marcellus Shale at flow rates exceeding 80 BBL/min. In an exemplary embodiment, onboard instrumentation and computer control ensure failsafe operation.

In hydraulic fracturing applications, the apparatus and method according to the present invention has been found to be highly effective at inactivating both aerobic bacteria and anaerobic bacteria such as acid producing bacteria (APB), sulfate reducing bacteria (SRB), and iron reducing bacteria (IRB). The system has been found to be highly effective even in highly algae-containing waters, produced waters with high salt content, and freshwater to a sufficiently high degree to eliminate or greatly reduce the need for chemical biocides during hydraulic fracturing. It is suitable for both gas shales and oil shale hydraulic fracturing.

Operating the system at a lower power level may reduce energy costs for produced water disinfection. The water produced from the apparatus and method according to the present invention has approximately 10³ CFU/ml bacteria levels vs typical 10⁵ CFU/ml bacteria levels in freshwater. Since the turbidity levels of the produced and fresh water were similar and the system has been able to completely eliminate bacteria from the higher bacteria count fresh water, it may be able to achieve the required bacteria inactivation rates with produced water at lamp power levels lower than described below.

Chemical biocides are inherently toxic and hazardous, creating hazards due to leaks and spills. Cemented joints along the well pipe can leak, possibly allowing biocides to seep from the well during fracturing. Reduction of chemical biocide use extends the number of reuse cycles possible from the produced fracing water, thereby reducing disposal costs. Unlike biocides and oxidants, fluid treated by the ultraviolet light does not break down the gelling agent nor crosslink the polyacrylamide-based friction reducers used in the fracing water. Transfer pumps and the electrical generator are the only consistently moving parts, thereby maximizing reliability.

The system may be preferably placed upstream of the blender (which is the device that adds proppant such as sand, and fracing chemicals or additives such as guar, to the disinfected water that is output by the system or upstream of a pump which transfers water to the frac pad) in hydraulic fracturing applications in order to keep pressure relatively low in the apparatus according to the present invention. A lined frac pond or frac tanks are the typical water source. Either produced water (which may have a high level of total dissolved solids (TDS)) or freshwater is typically used. Fresh water is usually pumped out of the ground or taken from a surface water source.

Optionally, according to one embodiment of the present invention, biocides may still be used in combination with the system, preferably as a residual disinfectant in the water to kill bacteria introduced after the water is disinfected by the system, instead of as a primary disinfectant. As currently utilized in the prior art, without water treatment according to the present invention, disinfection dosage levels for biocides are about 20 parts per million to about 100 parts per million or more. In contrast, when biocides are used for residual disinfection in conjunction with the apparatus and method of the present invention, dosages for such residual disinfection would be substantially lower, and would vary from about 0.25 parts per million or less to about 5 parts per million. Such a biocide may be graphene oxide, which may be used in conjunction with the system 2 as a residual disinfectant. According to another embodiment of the present invention, graphene oxide may be used as a biocide for fracing on its own, without utilizing the system 2.

According to an exemplary embodiment of the present invention, a complete system may be formed with six parallel sets of ultraviolet chambers operating in combination, each flowing ⅙ of the total system flow rate. Alternately, more or fewer sets of chambers may be used. The parallel flow provides inherent redundancy which allows an operator to divert water flow from one of the six parallel sets of chambers by simply closing one valve. Alternately, one or more ultraviolet chambers may be arranged relative to one or more other ultraviolent chambers in a manner other than parallel. As another exemplary feature, an automated valve may be attached to, or attached in fluid communication with, an inlet to at least one ultraviolet chamber, where that automated valve diverts water from an ultraviolet chamber set in the unlikely event of a lamp failure or ground fault.

The system has a wide variety of applications in addition to fluid purification for well stimulation. These applications include disinfection of wastewater, drinking water, industrial process water, cooling system water, and other fluid purification processes including air purification. The system is also useful for purifying water used for well flooding for treating water injected into wells to enhance oil and gas recovery. In these and other applications, the system can inactivate a wide range of aerobic and anerobic bacteria, viruses, protozoa, fungi, helminthes, yeast, and molds. The system is able to work with a wide range of fluid types including water and air and with a wide range of fluid pH levels and fluid compositions and impurity levels.

Advantages of the apparatus and method of the present invention include that the process is not temperature dependent nor pH dependent, except that fluids must be pumpable. The system can be rapidly set up at a well site or other location with a small footprint, and can be easily transported in a standard trailer. By using light rather than biocide to disinfect the fracing water, the apparatus and method according to the present invention eliminates the possibility of unwanted chemical reactions with the biocide, and does not interfere with the efficiency of chemicals used in the drilling/completion process.

The system is compact for the rate of fluid it purifies. The system is significantly smaller than the size of a conventional ultraviolet disinfection system for the same bacterial inactivation rate and liquid flow rate. The system provides greater bacterial inactivation power per watt than conventional single chamber ultraviolet disinfection systems. The compact size and greater energy efficiency are advantages that enable the system to be used on the typical small well pad while meeting the need for highly disinfected water for the fracing process.

One example of a fluid disinfection system includes a chamber through which fluid can flow, the chamber having an inlet through which fluid enters the chamber and an outlet through which fluid exits the chamber; a source for illuminating the chamber with ultraviolet light; and a plurality of baffles within the chamber for defining a multiplicity of subchambers within the chamber through which fluid to be purified flows from the inlet to the outlet; each subchamber being located to receive the ultraviolet light; where holes are defined through at least one baffle, and wherein those holes collectively define a fluid flow area that increases with the radial distance from the center of the baffle.

Another example of a fluid disinfection system includes chambers through which fluid can flow, each chamber having an inlet through which fluid enters the chamber and an outlet through which fluid exits the chamber; a source for illuminating each chamber with ultraviolet light; and baffles within each chamber for defining a multiplicity of subchambers within each chamber through which fluid to be purified flows from the inlet to the outlet; each subchamber being located to receive the ultraviolet light; where holes are defined through at least one baffle, and where the number of said holes increases with the radial distance from the center of the baffle; and further including at least one crossover tube, where at least two chambers are connected in series by at least one crossover tube, and where at least one crossover tube is located above the chambers connected by the crossover tube.

An example of a fluid disinfection method includes possessing a system that includes chambers through which fluid can flow, each chamber having an inlet through which fluid enters the chamber and an outlet through which fluid exits the chamber; a source for illuminating each chamber with ultraviolet light; and a plurality of baffles within each chamber for defining a multiplicity of subchambers within each chamber through which fluid to be purified flows from the inlet to the outlet; each subchamber being located to receive the ultraviolet light; where holes are defined through at least one baffle; and further including at least one crossover tube, where at least two chambers are connected in series by at least one crossover tube; passing fluid through the system at a flow rate of up to 100 barrels per minute; and disinfecting that fluid to a level of >99.9% bacterial inactivation with the ultraviolet light.

### BRIEF DESCRIPTION OF THE DRAWINGS

FIG. 1 is a top schematic view of an ultraviolet fluid disinfection system.

FIG. 2 is a perspective view of the fluid disinfection system of FIG. 1.

FIG. 3 is a detail perspective view of the fluid disinfection system of FIG. 2.

FIG. 4 is a bottom view of the fluid disinfection system of FIG. 1.

FIG. 5 is a perspective view of the fluid disinfection system of FIG. 1 within a trailer.

FIG. 6 is a perspective cutaway view of a chamber of the fluid disinfection system of FIG. 1.

FIG. 7 is a perspective view of an exemplary baffle used in the chamber of FIG. 6.

FIG. 8 is a perspective cutaway view of a simulation of the chamber of the fluid disinfection system of FIG. 1, showing flow streamlines.

FIG. 9 is a perspective cutaway view of a simulation of a chamber of a prior art fluid disinfection system, showing flow streamlines

FIG. 10 is a simplified perspective cutaway view of an end of a chamber of the fluid disinfection system of FIG. 1, showing a UV lamp and quartz tube.

FIG. 11 is a perspective view of a wiper system used to clean the quartz tube of FIG. 10.

FIG. 12 is a detail perspective view of the wiper of FIG. 11.

The use of the same reference symbols in different figures indicates similar or identical items.

### DETAILED DESCRIPTION

An ultraviolet water purification system suitable for purifying water for village or municipal use is described in U.S. Pat. No. 7,862,728 to Yencho (“Yencho '728”), which is hereby incorporated by reference herein in its entirety. The apparatus and method described below disclose an exemplary ultraviolet water purification system that is optimized for further suitability in purification of water at a high flow rate suitable for hydraulic fracing.

Apparatus

Referring to FIG. 1, an exemplary ultraviolet water disinfection system 2 is shown. The system 2 may include six sets 8 of two chambers 4 each. Alternately, more or fewer than six sets 8 of chambers 4 may be used. Alternately, more than two chambers may be included in at least one set 8. Each group of two chambers 4 is connected in series, with the six sets 8 of chambers 4 connected in parallel. The chambers 4 in a set 8 may be connected by a crossover tube 6, which may have any suitable size, shape and internal diameter. The crossover tube 6 may be bolted or otherwise affixed to the chambers 4, and may be detachably affixed (as with bolts) to allow for disassembly for cleaning, maintenance and/or repair. Alternately, the chambers 4 in a set 8 may abut one another directly, such that the outlet of one chamber 4 flows directly into the inlet of the next chamber 4. Alternately, the chambers 4 in a set 8 may be connected to one another in any other suitable topology and/or with any suitable fluid interconnection. As another example, chamber 4 may be used singly rather than in combination with one or more other chambers 4. As another example, at least one set 8 of chambers 4 may be connected to at least one other set 8 of chambers 4 in a manner other than parallel. Advantageously, each chamber 4 includes a removable end plate or end cap at each end, to facilitate cleaning and repair of the chamber 4. The end plate or end cap may be bolted onto the remainder of the chamber 4, or attached to the remainder of the chamber 4 in any other suitable manner that provides for both detachment and for leakproof attachment. Each chamber 4 may have any suitable size and/or shape. As one example, the chambers 4 may be cylinders that may have an outer diameter of substantially 20.5 inches, and a length of substantially 124 inches. As another example, at least one of the chambers 4 has a different shape, outer diameter and/or length.

Referring also to FIG. 2, the inlet to the first chamber 4 of each set 8 may be connected to an inlet tube 10, which in turn may be connected to an inlet manifold 12. The phrase “first chamber of a set” refers to the first chamber in the set 8 that receives water flowing in from outside the system 2. The inlet tubes 10 and inlet manifold 12 may have any suitable shape, size and/or internal diameter, and may be connected to each other and/or the first chamber 4 of each set in any suitable manner, such as by welding or bolting. As one example, the inlet manifold 12 may be substantially cylindrical, and may be oriented substantially perpendicular to at least one chamber 4. As another example, at least one inlet tube 10 may be substantially L-shaped, may extend substantially laterally outward from the inlet manifold 12, then turn downward to extend to its connection to the chamber 4. Alternately, the inlet manifold 12 may be connected directly to the inlet of at least one chamber 4, without an intervening inlet tube 10. The inlet manifold 12 preferably is located above the level of the chambers 4 to allow air to escape from the chambers 4, and to constrain the water for maximum UVC irradiation inside each chamber 4. A bleed valve 14 may be connected to the inlet manifold 12, to allow for manual or automatic bleedoff prior to startup of air that has escaped from water held in the chambers 4 and/or the inlet manifold 12. Fluid may enter the inlet manifold 12 in any suitable manner. As one example, one or more inlet ports 22 may be located below the inlet manifold 12, and may be connected to the inlet manifold 12 by an inlet supply tube 24. The inlet ports 22 may be located below, above or at the same level as the inlet manifold. Alternately, the inlet ports 22 may be located on the inlet manifold 12 itself. The inlet ports 22 may have any suitable interface connection, and advantageously allow for the connection of water at a frac site using industry-standard water connectors. A strainer (not shown) optionally may be located in the inlet supply tube 24 in proximity to the inlet ports 22 or in the inlet manifold 12, to prevent larger-scale foreign material from entering the system. Such foreign material may include dirt, rocks and sand. The strainer is configured for removal and cleaning. Alternately, a strainer may be provided upstream from the inlet ports 22, such that larger-scale foreign material is removed from the water before it enters the system. Referring also to FIG. 3, the system 2 may incorporate a pressure relief valve or rupture disc 26 on the inlet supply tube 24 or the inlet manifold 12 of the system 2 to protect the system 2 in the event of an overpressurization. The rupture disc 26 is preferentially a graphite disc with a butterfly valve 28 behind it. Alternately, a spring-loaded pressure relief valve may be used. The rupture disc preferably may be set to release at about 100 psi. The specific pressure at which the rupture disc or other pressure relief valve releases may vary depending on the particular components of the system 2 and their pressure tolerance.

Referring also back to FIG. 2, similarly, the crossover tubes 6 preferably are located above the level of the chambers 4 to allow air to escape from the chambers 4, and to constrain the water for maximum UVC irradiation inside each chamber 4. A bleed valve 16 may be connected to one or more of the crossover tubes 6, to allow for manual or automatic bleedoff prior to startup of air that has escaped from water held in the chambers 4 and/or the crossover tube 6. Empirically, it has been determined that placement of the crossover tube 6 above the two chambers 4 it connects is necessary in order to maintain the desired flow pattern for the system 2. Without wishing to be bound to a particular theory, it is believed that the initial “waterfall” into the chamber 4 from the crossover tube 6 may play a part in setting up the cylindrical flow pattern within the first subchamber 46, as described in greater detail below, and this flow pattern may carry over to subsequent subchambers 46 as a result of its generation in the first subchamber 46 of the chamber.

The outlet from the last chamber 4 of each set 8 may be connected to an outlet tube 18, which in turn may be connected to an outlet manifold 20. The phrase “last chamber of a set” refers to the last chamber in the set 8 that receives water flowing in from outside the system 2. The outlet tubes 18 and outlet manifold 20 may have any suitable shape, size and/or internal diameter, and may be connected to each other and/or the last chamber 4 of each set 8 in any suitable manner, such as by welding or bolting. As one example, the outlet manifold 20 may be substantially cylindrical, and may be oriented substantially perpendicular to at least one chamber 4. As another example, at least one outlet tube 18 may be substantially L-shaped, may extend substantially laterally outward from the outlet manifold 20, then turn downward to extend to its connection to the chamber 4. The outlet tubes 18 and the inlet tubes 10 may have an outer diameter of substantially 8 inches. Alternately, at least one of the tubes 10, 18 may have a different outer diameter. Alternately, the outlet manifold 20 may be connected directly to the inlet of at least one chamber 4, without an intervening outlet tube 18. The outlet manifold 20 preferably is located above the level of the chambers 4 to allow air to escape from the chambers 4, and to constrain the water for maximum UVC irradiation inside each chamber 4. A bleed valve 23 may be connected to the outlet manifold 20, to allow for manual or automatic bleedoff prior to startup of air that has escaped from water held in the chambers 4 and/or the outlet manifold 20. Referring also to FIG. 4, water flows out of the outlet manifold 20 through one or more outlet ports 25, which may be configured in a similar manner to the inlet ports 22. Thus, water flows into the inlet manifold 12, then through the inlet tubes 10, then through the first chamber 4, the crossover tube 6, and the second chamber 4, then through the outlet tubes 18 and into the outlet manifold 20, after which it flows through the outlet ports 25 to exit the system 2.

Referring also to FIG. 4, the system 2 optionally includes a bypass tube 30 which enables the water flow to entirely bypass the chambers 4. The system 2 can be taken offline rapidly and the chambers 4 protected from contamination in the event of a source water contamination by actuating valves on the unit. Referring also to FIG. 2, a butterfly valve 27 may be mounted in the inlet supply tube 24 at any suitable location. As one example, the butterfly valve 27 may be located between the inlet manifold 12 and the inlet supply tube 24. That butterfly valve 27 may be manually or automatically actuable. The butterfly valve 27 is sized as appropriate for the inlet supply tube 24, and as one example may have substantially a 12″ diameter. When the butterfly valve 27 is open, the system 2 operates normally and the input water flows normally into the inlet manifold 12. The butterfly valve 27 may be closed if, for example, water contaminated with oil or other unexpected contents is proceeding toward the system 2; in this way, the chambers 4 and their contents can be protected. When the check valve is closed, water flows into the one or more input ports 22, into the inlet supply tube 24, and is blocked from entering the inlet manifold 12. The water may then exit the inlet supply tube 24 through the exit port or ports 110. The exit port or ports 110 themselves are each opened by a valve (not shown) adjacent to the corresponding exit port 110. When the exit port or ports 110 are opened, the water may exit the inlet supply tube 24 through the exit port or ports 110, and then enter at least one bypass tube 30. One bypass tube 30 may correspond to each exit port 110. Each bypass tube 30 may connect an exit port 110 on the inlet supply tube 24 to a bypass entry port 114 on the outlet manifold 20. The bypass entry port or ports 114 themselves are each opened by a valve (not shown) adjacent to the corresponding bypass entry port 114. Thus, when the appropriate valves are opened and closed, water that enters the system 2 can be diverted away from the chambers 4, directly from the inlet supply tube 24 (which may be considered part of the inlet manifold 12) to the outlet manifold 20. Butterfly valve 28 adjacent to or in fluid communication with the outlet manifold 20 can be manually or automatically closed to prevent the outlet manifold 20 from receiving contamination from the bypassed flow.

The components described with regard to FIGS. 1-4 may be mounted on a frame 40. By mounting the components on a common frame, portability and transportability of the system 2 is enhanced, as motion of the frame 40 moves the entire system. Referring also to FIG. 5, the frame 40 may be mounted to or placed inside a wheeled trailer 38, such as a standard semi trailer configured to be pulled by a standard road tractor in a standard tractor-trailer configuration. The entire system 2 thereby may be held within the wheeled trailer. By placing the system 2 inside a trailer 38, the system 2 also may be protected from the weather, from curious passersby, and/or from sabotage, Alternately, the frame 40 itself may be wheeled, rather than placed inside a trailer 38, such that the system 2 is exposed and portable. Alternately, the system 2 need not be mounted to a frame, and may be otherwise portable, or may be assembled on site from individual components. At least one heater 70 may be located within the trailer 38. The heater 70 allows for cold weather operation of the system down to at least 25° F. (−4 C.) and provides system protection at temperatures of 0° C.F (−18 C.) or lower. Alternately, the system 2 may be assembled within a temporary or permanent structure, and utilized within that structure for any suitable amount of time.

Referring also to FIG. 6, each chamber 4 includes a plurality of baffles 42 longitudinally spaced apart from one another to form subchambers 46. The longitudinal direction is the direction along which the centerline of the cylindrical shape of the chamber 4 extends. The baffles 42 may be evenly spaced apart from one another, or may be differentially spaced apart from one another. The spacing of the baffles 42 apart from one another may vary along the length of the chamber 4. An input port 44 may extend through the wall of the chamber 4, and may be located between an end of the chamber 4 and the first baffle 42. The “first baffle” refers to the first baffle 42 in the chamber 4 that encounters water from outside the chamber 4 in the course of normal operation. Water enters the chamber 4 through the input port 44 from the inlet manifold 12, via the inlet tube 12 if the inlet tube 12 is used. An output port 52 may extend through the wall of the chamber 4, and may be located between an end of the chamber 42 and the last baffle 42. The “last baffle” refers to the baffle 42 within the chamber 4 longitudinally spaced the furthest from the first baffle 42. Water exits the chamber 4 through the output port 52, traveling into the outlet manifold 20, through the outlet tubes 18 if used. The baffles 42 may be attached to the chamber 4 in any suitable manner, such as by welding, interference fit or bolting. As one example, referring also to FIG. 7, at least one baffle 42 may include baffle mounts 48 spaced around its periphery for mounting the baffle to the wall of the chamber 4. The baffle mounts 48 may be cylindrical pegs, or may have any other suitable shape. The baffle mounts 48 may protrude through corresponding holes 50 through, or divots or notches in the inner surface of, the wall of the chamber 4, and may be welded to the outer surface of the chamber 4 from the outside to achieve structural integrity for the baffle 42 and a liquid-tight chamber 4. Alternately, to improve the manufacturability of the system 2, each chamber 4 may be fabricated by two or more partial cylinders which contain slots to receive baffle mounts 48 or tabs from the baffles 42. The baffle mounts 48 or tabs then may be welded to the outer wall of the chamber 4, and the partial cylinders may be welded together to complete fabrication of the chamber 4.

Referring also to FIG. 7, the baffles 42 may include a central aperture 54. Each baffle 42 may be generally circular or polygonal, and may be generally disk-shaped. The central aperture 54 advantageously includes the geometric center of the baffle 42. When the baffles 42 are arranged within the chamber, the central apertures 54 may be substantially longitudinally aligned with each other. Referring also to FIG. 10, a quartz tube 60 may extend longitudinally along part or all of the length of the chamber 4. Advantageously, the quartz tube 60 may be annealed to remove residual stress arising from the manufacturing process to increase its resistance to impact and reduce the incidence of tube fracture. The quartz tube 60 may be coated with a UVC transparent material or ion implanted to reduce the buildup of exopolymer secreted by bacteria in the system. The quartz tube advantageously may have an inner diameter of 35 mm and an outer diameter of 38 mm. Inside each quartz tube, a UV lamp 62 is located. As one example, a medium pressure mercury lamp may be utilized as a UV lamp. However, a different type of light source, such as a low pressure mercury lamp, a microwave-powered UV lamp, a light emitting diode or laser, may be used if it is capable of emitting a suitable amount of UV radiation at least as great as a medium pressure mercury lamp. Advantageously, the UV lamp emits UV light in the UVC range, which is generally from 100 nm to 280 nm.

Optionally, drain notches 57 may be made at the top and/or bottom of at least one baffle 42, along the edge. The drain notch 57 at the bottom of the baffle 42 allows for drainage of all subchambers 46 when the chamber 4 is drained for cleaning or for any other reason. The drain notch 57 at the top of the baffle 42 allows any air trapped in a subchamber 42 to escape and work its way toward either the inlet manifold 12 or the outlet manifold 20. The drain notches 57 are sized to be small enough such that only a minimal amount of water that passes through the chamber passes through those notches 57, and such that a jet effect of water through successive notches 57 in successive baffles 42 along the chamber 4 is avoided.

Referring also to FIG. 10, advantageously the system 2 is optimized to minimize energy use while achieving high bacteria kill rates. Advantageously, the operating temperature of the UV lamp 62 is in the range of substantially 600-800° C. If the UV lamp 62 radiates and convects too much heat to the quartz tube 60 and the water, the UV lamp 62 may not reliably start, and/or may run too cool for proper operation. On the other hand, if the UV lamp 62 does not radiate enough heat to the quartz tube 60 and the water, the UV lamp 62 may operate at too high a temperature and may consequently fail prematurely. The UV lamp 62 is held within the quartz tube 60. A gap 64 separates the UV lamp 62 from the inner surface of the quartz tube 60. The gap 64 may be filled with air, inert gas, vacuum, or any other suitable gas. Alternately, the gap 64 may be filled with any suitable liquid. The width of the gap 64, and the thickness of the wall of the quartz tube 60, both may be adjusted in order to provide for operation of the UV lamp 62 in its optimum temperature range. As one example, the gap 64 between the UV lamp 62 and the inner surface of the quartz tube 60 is substantially 2.5 mm, and the thickness of the quartz tube 60 is substantially 1.5 mm. Alternately, the gap 64 and/or thickness of the quartz tube 60 may be different. As one example, the UV lamp 62 may be substantially 124″ long, and may have an outer diameter of substantially 30 mm. Alternately the UV lamp 62 may have a different length and/or different outer diameter. Further, due to the high flow rate of the water through the chamber 4 and the high convection and radiation rate of heat to the water, in steady-state operation of the system 2, the surface of the quartz tube 60 that is in contact with water moving through the chamber 4 is generally within 10° C. of the temperature of the water flowing through the chamber 4.

Aluminum has a high degree of UVC reflectivity, which is partially why aluminum is preferentially used for the chambers 4. Preferably, a 6061-T6 or 5052 aluminum alloy may be used, both of which have substantially higher reflectivity than stainless steel even when hard anodized. However, any other suitable aluminum alloy or material may be used to fabricate the chamber 4. Further, the chamber walls are coated or anodized to prevent corrosion, especially corrosion which is caused by high salinity produced water. The anodized chambers, while having less than perfect UVC reflectance, still exhibit a high degree of UVC reflectivity. The preferred coating is a thin hard anodized surface. Alternately, the chambers may be fabricated of stainless steel, low carbon steel, or another material.

UVC light from the lamp 62 at the center of the chamber 4 transmits through the fluid in the chamber 4 and reflects from the wall of the chamber 4. Since the level of irradiation of fluid in the chamber drops off as 1/r² with distance from the outer surface of the quartz tube 60, more fluid should correspondingly flow through the center of the chamber 4 than the outer periphery of the chamber 4 in order to optimize the level of fluid irradiation in the chamber 4. A model was constructed which summed the incident radiation from the lamp 62 and the reflected radiation from the wall of the chamber 4 at each radial location in the chamber 4, including assumed losses of 50% of remaining light intensity at the point of reflection. UVC transmissivity data from field water samples was also used in the development of the chamber to so that accurate UVC fluid transmissivity levels were employed. Using this model, the baffle 42 was divided into radial zones and the sum of flow area for optimal irradiation was computed for each zone to maintain approximately the ratio of water flow to UV radiation from both lamp and wall on fluid elements passing through each zone to optimize chamber 4 efficiency. These computations produced generally the baffle hole pattern shown in FIG. 7.

Referring also to FIG. 7, the baffle 42 may include a plurality of inner holes 45 defined therethrough, and a plurality of outer holes 43 defined therethrough. The inner holes 45 are located radially closer to the central aperture 54 of the baffle 42 than the outer holes 43. As one example, the outer holes 43 may have substantially the same size as one another. As another example, one or more outer holes 43 may be sized differently from one another. As another example, the outer holes 43 may reduce in area and/or diameter, linearly or exponentially, individually or collectively, with increased radial distance from the central aperture 54. The collective area defined by the inner holes 45 and outer holes 43 may be referred to as the fluid flow area. The outer holes 43 may extend out to a location near the edge of the baffle 42, or may extend across at least half of the diameter of the baffle 42.

The inner holes 45 in each baffle 42 advantageously are larger than the outer holes, and may be shaped differently. As one example, at least one inner hole 45 may have two semicircular ends, with a rectangular segment in between as shown in FIG. 7. As another example, at least one inner hole 45 may be oval or rectangular. The larger size of the inner holes 45 as compared to the outer holes promotes sufficient water flow along the center of the chamber 4, and allows for large particles to pass through the chamber 4 without blocking the inner holes 45. As another example, the inner holes 45 may be the same size as the outer holes 43. If so, there may be more than six inner holes 45 through a baffle 42, in order to promote sufficient water flow along the radial center of the chamber 4.

The outer holes 43 in each baffle 42 may have any suitable size and shape. For example, the outer holes 43 may be substantially circular, and may range from 20 mm to 40 mm in diameter in to control fluid motion and allow for large particles to pass through the chamber 4 without blocking the outer holes 43. As another example, the outer holes 43 may be substantially circular, and may have a larger or smaller diameter. As another example, the outer holes 43 may be any other suitable shape, such as an irregular or polygonal shape. As another example, the outer holes 43 need not all have the same shape and/or size, and at least one of the outer holes 43 may be shaped and/or sized differently from at least one of the others.

Generally, the pattern of holes 43, 45 in the baffle 42, and the sizes of those holes, are selected to promote fluid flow closer to the central aperture 54 and thus closer to the quartz tube 60, in order to expose a greater fraction of water to the more intense UV light closer to the quartz tube 60 and to allow that water to move faster, and in order to expose a lesser fraction of water to the less intense UV light further from the quartz tube 60, and restrict that water to moving slower. The holes 43, 45 in the baffle 42 may form two or more concentric rings 55 centered substantially on the central aperture 54. One of those rings 55 is shown on FIG. 7 as a convenience for visualization rather than to illustrate a real structure. The holes 43, 45 may be organized into concentric rings 55 that are substantially equally radially spaced from one another. However, the radial distance that at least one of the rings 55 is spaced apart from at least one adjacent ring may vary, in order to promote the desired fluid flow pattern. As shown in FIG. 7, the number of holes 43, 45, in each successively-further ring from the central aperture 55 increases by 6, and there are six inner holes 45. Thus, as one example, the outermost ring 55 on the baffle 24 may include at least, or no more than, four times the number of outer holes 43 as the number of inner holes 45, particularly where the outer ring 55 is the fourth ring out from the central aperture 54. Regardless of the number of holes 43, 45 in each ring 55, the collective hole area in each ring 55 is no smaller than, and is preferentially larger than, the collective hole area in the ring 55 concentrically closer to the central aperture 54. Further, while the collective hole area in each ring 55 is preferentially larger than the collective hole area in the ring 55 concentrically closer to the central aperture 54, it is larger by a factor of less than the square of the collective hole area in the ring 55 concentrically closer to the central aperture 54. Indeed, preferably the collective hole area in each ring 55 is larger than the collective hole area in the ring 55 concentrically closer to the central aperture 54 by a linear, and not an exponential, factor.

The holes 43, 45 need not be organized into rings 55 around the central aperture 54, and indeed no hole 43, 45 need be at the same radial distance from the central aperture 54 as any other hole 43, 45. If so, the baffle 42 may be divided into an arbitrary number of concentric bands, each having an equal radial dimension. The collective hole area within each band thus may be no smaller than, and preferably larger than, the collective hole area in the ring 55 concentrically closer to the central aperture 54. Further, while the collective hole area in each band is preferentially larger than the collective hole area in the band concentrically closer to the central aperture 54, it is larger by a factor of less than the square of the collective hole area in the band concentrically closer to the central aperture 54. Indeed, preferably the collective hole area in each band is larger than the collective hole area in the band concentrically closer to the central aperture 54 by a linear, and not an exponential, factor.

As another example, more-random hole patterns may be utilized, in which the holes 43, 45 are not organized into rings 55 around the central aperture 54. If so, the baffle 42 may be divided into an arbitrary number of concentric bands, each having an equal radial dimension. The holes 43, 45 may be arranged such that the trend in collective hole area across the baffle 42 from the central aperture 54 out to the outer edge 49 is from smaller to larger, even though the collective hole area in a particular band may be smaller than the collective hole area in the ring 55 concentrically closer to the central aperture 54.

Referring also to FIG. 8, a computational fluid dynamic simulation of the chamber 4 is shown, using the baffles 42 and baffle hole pattern of FIG. 7. The fluid enters the chamber 4 through the input port 44, then flows successively through a series of subchambers 46 in each chamber 4, each of which illuminate the fluid with UVC light emitted from the lamp 62 through the quartz tube 60. The fluid flow is optimized as shown to circulate the fluid in each subchamber 46 in a rotating pattern approximately centered in the subchamber 46. The rotating pattern is that of a cylinder rotating clockwise, about an axis that is perpendicular to the longitudinal axis of the chamber 4. Generally, that axis is transverse to the longitudinal axis of the chamber 4. This rotating pattern allows at least some of the fluid within a subchamber 46 to be exposed to UV light for a longer time in that subchamber 46 than if the baffles 42 defining that subchamber 46 were not present, and at the same time does not restrict the fluid within the subchamber 46 for a long enough time to disrupt the flow of the fluid. Advantageously, at least half of the water in at least one subchamber 46 preferably rotates completely through said cylindrical pattern at least once. A complete rotation refers to a rotation of substantially 360 degrees about the axis of that cylinder. The baffles 42 add pressure loss to the system 2, but provide for a more uniform inactivation of bacteria. Without wishing to be bound to any particular theory, it is believed that the cylindrical flow pattern within each subchamber 46 is a result of the linear pressure drop across the entire chamber 4 and the particular distribution of holes in the baffles 42.

Referring also to FIG. 9, a computational fluid dynamic simulation of the system of the Yencho '728 patent is shown. The fluid flow in the subchambers of Yencho′728 is substantially toroidal, as seen in the cross-section view of the chamber that is FIG. 9, like a doughnut that fills each subchamber, with the lamp extending through the doughnut hole. The fact that the fluid principally moves between subchambers at an annular opening surrounding the cylindrical lamp creates that toroidal flow, because of asymmetrical drag through that annular opening. Fluid flows smoothly and laminarly along the smooth surface of the lamp, and flows the flow experiences higher losses as it passes by the edge of the baffle oriented toward the lamp. Thus, the fluid rotation in each subchamber of Yencho '728 is centered along the longitudinal centerline of the chamber.

The computational flow models of FIGS. 9-10 show that the ratio of flow rate to dwell time (or “flowto dwell”) of the present system is larger than the ratio of flow to dwell described in the Yencho '728 patent, in which the ratio of flow to dwell is substantially larger. In this way, the system 2 of the present invention is able to handle a high flow rate of substantially 100 barrels per minute, without the need for a chamber 4 so long or so wide that it could not fit on a trailer 38. Further, the computational flow models of FIGS. 8-9 show the counterintuitive and unexpected result that disinfection of water at a high flow rate is more effective at a high flow to dwell ratio that preserves a relatively high flow rate through the chambers 4.

The pressure drop along a chamber 4, and along multiple chambers 4 connected in series, is relatively low: approximately 7 to 10 psi at a flow rate of 100 barrels per minute, as measured during testing. This is due to the relatively low pressure of the water or other fluid at the inlet of the system 2. If the fluid pressure at the inlet of the system 2 were high, the combination of that fluid pressure and the high flow rate through the system 2 would require the baffles 42 to be substantially thicker in order to withstand the force of the fluid passing therethrough. The quartz tube 60 would likely need to be thicker as well, which would reduce heat dissipation and therefore necessitate a reduced power output from the UV lamp 62, rendering it less effective. The walls of the chamber 4, as well as the walls of the other fluid-holding components of the system 2, would likely need to be thicker as well. Consequently, maintaining the inlet pressure at a relatively low level, and using the flow rate rather than pressure to drive fluid through the chambers 4, results in a lighter and more compact system 2. Due to the relatively low pressure drop across the system, the output manifold 20 may operate in a vacuum as the downstream transfer pump (which is not part of the system 2, and which is located downstream of the system 2) pulls water through the system 2. A transfer pump upstream of the system 2 may be needed to provide pressure at the system exit for proper performance of the downstream transfer pump to compensate for pressure losses in the system 2 and in the piping leading to and from the system 2.

Referring also to FIG. 5, the system 2 may include one or more ballasts 90, shown schematically in that figure. Separate capacitors also may be provided in conjunction with the one or more ballasts 90. The ballast or ballasts 90 act to convert standard sine wave pattern AC power to the particular waveform that optimizes UVC output from the UV lamp 62. The ballast or ballasts 90 are standard off-the-shelf equipment, and the selection of a particular ballast 90 is known to one of ordinary skill in the art. Optionally, depending on the particular type of UV lamp 62 utilized, the ballast 90 may not be required, and may be replaced with a different type of power supply, or wired high-voltage power. The selection of a power source matched to the UV lamp 62 is known to one of ordinary skill in the art. The ballast or ballasts 90 may be located inside the trailer 38, and may assist in heating the trailer 38 in cold weather. The ballast or ballasts 90 may be placed in a separate compartment within the trailer 38 that can be cooled, if desired. Alternately, the ballast or ballasts 90 can be located outside the trailer 38 and connected to a remainder of the system 2 in any suitable manner. Optionally, a generator (not shown) may be located inside the trailer 38 as well, for powering the system 2. Alternately, that generator can be located outside the trailer 38 and connected to a remainder of the system 2 in any suitable manner. Alternately, a generator is not used, and the system 2 is connected to utility power at the well site or other point of use.

Referring also to FIGS. 11-12, optionally, at least one wiper system 120 may be provided in association with each quartz tube 60. The secretions from and remnants of dead bacteria in the water may build up over time on the quartz tube 60, reducing its UV transmissivity. The wiper system 120 allows for rapid cleaning of the protective quartz tubes 60 surrounding the UV lamps 62 in the field on a periodic basis during the time between frac stages. The wiper system 120 for the unit may be manually operated or automated. An automated wiper system 120 may actuate the wiper body 122 on a timed basis, after the passage of a set number of minutes or hours, or may actuate the wiper body 122 based on sensor feedback related to the amount of UVC light emitted through the quartz tube, such that a reduction of transmitted UV light over time greater than a preset amount causes actuation of the wiper body 122.

The wiper system 120 includes a wiper body 122. The wiper body 122 preferentially has numerous openings 124 therethrough allowing for thermal and UVC radiation to pass through and also enabling convection cooling of the quartz tube 60 surface. The openings 124 may be laser cut in the wiper body 122 or may be otherwise fabricated. To maximize radiation transfer to the water and to minimize the heating of water trapped between the wiper body 122 and the quartz tube 60, the wiper body 122 is preferentially fabricated with thin struts or other thin metal components. The wiper body 122 is preferentially constructed of anodized aluminum or brass or other highly thermally conductive material to dissipate heat absorbed from the UV lamp 62 by radiation and by convection. The wiper body 122 may have chamfers 126 on each end to ease its passage through the central apertures 54 of the baffles 42. The wiper body 122 preferably has at least one circumferential elastomeric wiping element made from fluoroelastic polymer (FKM, FPM), Viton, or other fluoroelastomer. It may have a PTFE of other lubricious, UVC resistant bushing at the other end.

The wiper body 122 is preferably pulled along the quartz tube 60 by an FEP coated stainless steel multi-stranded cable 130. Alternately, any other suitable cable 130 may be used. The cable 130 preferentially is crimped or silver soldered or otherwise structurally connected to each end of the wiper body 122, but may be connected to the wiper body 122 in any other suitable manner. Only one cable 130 is needed on each end of the wiper to minimize shadowing of the water from the UV lamp 62. The cable 130 preferably passes through a guide tube 132 and past a rod seal 134, preferably of an x-ring or o-ring shape, and then exits to a motorized reel 136 which winds and unwinds the cable 130, pulling the wiper body 122 along the quartz tube 60. Alternately, the reel 136 is operated manually and is not motorized. Alternately, the reel 136 is omitted and the cable 130 is simply taken up by hand as it exits the rod seal 134. The other end of the cable 130 is preferentially attached to a spring reel or other mechanism that keeps the cable 130 in substantially constant tension at any location along the quartz tube 60. The wiper body 122 is preferentially parked at the end of the quartz tube 60 for system operation. It may be positioned within a central aperture 54 of a baffle 42 near the longitudinal center of the chamber 4 to stabilize and cushion the quartz tube 60 from impacts during transportation. A similar guide tube 132, rod seal 134, and motorized or unmotorized spring loaded reel 136 may be additionally provided at the opposite end of the chamber 4, in order to move the wiper body 122 in the opposite longitudinal direction along the quartz tube 60 during the next cleaning operation.

As another example of the system 2, thin wires or electrodes may be placed along the quartz tube 60 and pulsed with electrical current to lyse the bacteria to prevent buildup along the quartz tube 60. Alternately, the system 2 may employ electrical contacts spaced in the chamber 4 and/or along the quartz tube 60 which conduct electrical pulses to lyse the cell walls of the bacteria to prevent the build-up of bacteria and the exopolymer along the quartz tube 60. Such thin wires or electrodes may be placed in intervals between the rolled layers of reverse osmosis membranes in a reverse osmosis water disinfection or desalination system to prevent biofouling, which is responsible for a significant portion of the energy required for reverse osmosis, system operation.

Instead of or in addition to the UV lamp 62, an array of piezoelectric ultrasonic transmitters may be placed around the outside diameter of the chamber 4 to inactivate bacteria though sonolysis. In this embodiment, the chamber 4, regardless of the shape of the chamber 4, ultrasonic waves are transmitted to inactivate the bacteria or for periodic use in cleaning the chambers. The UV lamp 62 in the center of the chamber 4 may also be replaced with a stainless steel tube having an array of piezoelectric ultrasonic transmitters spaced along the inside diameter to generate ultrasonic waves to sonolyze the fluid passing through the chamber 4. In this embodiment, ultrasonic waves radiate from the center vibrating tube element.

Operation

Operation of the system 2 is straightforward. A water source is connected to one or more of the inlet ports 22. The butterfly valve 27 upstream of the inlet ports 22 may be opened, and water or other fluid then enters the inlet manifold 12 through the butterfly valve 27. The water continues to flow through the first chamber 4, the crossover tube 6, the second chamber 4, and then into the outlet manifold 20. The butterfly valve 27 or the water source may then be shut off. Optionally, the water may be allowed to continue to flow through the system 2 during startup, but if so, such water is not used for fracing operations as it is not disinfected by the system 2 if the system 2 is off. The bleed valves 14, 16 and 23 are then opened, to allow air or other entrained gas to escape that has collected into the inlet manifold 12, crossover tube or tubes 6, and outlet manifold 20, respectively. Optionally, the water in the system 2 may be allowed to sit for a period of time in order to outgas prior to opening the bleed valves 14, 23. After outgassing, the bleed valves 14, 23 are closed once again.

The UV lamp 62 may then be started. The UV lamp 62 in each chamber is connected to the corresponding ballast 90 in any suitable manner, if the UV lamp 62 is not hardwired to the ballast 90. The UV lamp 62 is brought up to its desired operating temperature, such as in the range of 600-800° C. A sensor (not shown) in the system 2 may be used to measure the voltage across the UV lamp 62, or an empirical relationship between time and temperature may be used to determine that the UV lamp 62 has reached its desired operating voltage after the passage of a known amount of time.

The butterfly valve 27 is then reopened, and/or the water source is turned back on. Water begins to flow through the system 2 along the same path described above, at a flow rate of up to approximately 100 barrels per minute. As the water flows through each chamber 4, it flows through successive subchambers 46. As the water enters each successive subchamber 46, it enters a cylindrical flow pattern within that subchamber 46 as a consequence of the flow rate and the hole pattern in the baffles 42, as described in greater detail above. As the water continues to traverse the chambers 4, the temperature of the quartz tube 60 in each chamber preferably is maintained at a temperature within 10° C. of the temperature of the water flowing within that chamber 4. As another example, the temperature of the quartz tube 60 may vary a greater or lesser amount relative to the temperature of the water flowing through the chamber 4. The water completes its traverse of the chambers 4, enters the outlet manifold 20, and from there is output from the system 2 through the outlet port or ports 25. When the water exits the system, greater than 99.9% of the bacteria that had been present in the water when that water entered the inlet ports 22 has been killed.

Advantageously, the system 2 is fabricated to withstand a full vacuum and at least +70 PSI maximum operating pressure, preferably with at least a design safety factor of 1.5. The inlet manifold 12 and outlet manifold 20 are preferably hardened to safely handle high pressures. The high pressure rating enables easier operation in the field with less concern about overpressurizing the unit due to pump operator mistakes, or due to valves inadvertently being closed downstream of the unit if the water transfer pump operator over-revs the feeder pump or mistakenly closes downstream valves while the feeder pump is running at high speed. The feeder pump is located outside of the system 2, and is a standard apparatus in the fracing art that is known by those of ordinary skill in the art.

Downstream from the system 2, proppant (typically, but not limited to, sand) is added to the disinfected water by the blender, which is a standard apparatus in the fracing art and which is known by those of ordinary skill in the art. The proppant may be laden with bacterial contaminants, particularly if it is wet and if it has been extracted from a wet local source. Optionally, a pulsed high potential electric field is applied to the proppant before, or while, the proppant is added to the disinfected water. In this way, re-contamination of the disinfected water with bacteria from the proppant is avoided.

Periodically, the system 2 may be shut down for cleaning. If so, the UV lamp 62 is turned off, and the butterfly valve 27 is closed and/or the water source is disconnected from the inlet ports 22. The inlet ports 22 and outlet ports 25 are opened, and water is allowed to drain. One or more cleaning valves (not shown) may be opened to facilitate drainage of the water out of the chamber 4. Then, the ports 22, 25 and any cleaning valves are closed, and the chambers 4 may be filled with an aqueous cleaning agent to remove deposits on chamber walls and quartz tubes. The chambers 4 may be filled via the inlet ports 22, in which case the inlet ports 22 are opened to allow the cleaning agent to be pumped into the system. Alternately, the cleaning agent may be introduced into the chambers 4 and/or into the system as a whole by any other suitable method. A wide variety of cleaners may be used, such as ozone, hydrogen peroxide, sodium ferrate or chlorine dioxide or other oxidizer or mixed oxidants. Acids may also be used. Nontoxic cleaners such as citrus oil and surfactant may be used to lyse and clean bacteria the exopolymer produced by bacteria as well as algae stains from the chambers.

Other Disinfecting Applications Using System

While the present system 2 has been described in terms of its use in hydraulic fracing, the system 2 has a wide variety of applications in addition to fluid purification for well stimulation. These applications include disinfection of wastewater, drinking water, industrial process water, cooling system water, and other fluid purification processes. These fluid purification processes are not limited to liquids, and include fluids in a gaseous state, such as air; this system 2 may be used for gas treatment, including air purification. The system 2 is also useful for purifying water used for well flooding, and for treating water injected into wells to enhance oil and gas recovery. In these and other applications, the system 2 can inactivate a wide range of aerobic and anerobic bacteria, viruses, protozoa, fungi, helminthes, yeast, and molds. The system 2 is able to work with a wide range of fluid types including water and air and with a wide range of fluid pH levels and fluid compositions and impurity levels. While the structure and operation of the system 2 has been described in terms of water disinfection, that same description applies to the structure and operation of the system 2 for disinfection of other fluids, whether liquid or gas.

While the invention has been described in detail, it will be apparent to one skilled in the art that various changes and modifications can be made and equivalents employed, without departing from the present invention. It is to be understood that the invention is not limited to the details of construction, the arrangements of components, and/or the method set forth in the above description or illustrated in the drawings. Statements in the abstract of this document, and any summary statements in this document, are merely exemplary; they are not, and cannot be interpreted as, limiting the scope of the claims. Further, the figures are merely exemplary and not limiting. Topical headings and subheadings are for the convenience of the reader only. They should not and cannot be construed to have any substantive significance, meaning or interpretation, and should not and cannot be deemed to indicate that all of the information relating to any particular topic is to be found under or limited to any particular heading or subheading. Therefore, the invention is not to be restricted or limited except in accordance with the following claims and their legal equivalents.

What is claimed is:

1. A fluid disinfection unit, comprising:
a chamber through which fluid can flow, said chamber having an inlet through which fluid enters said chamber and an outlet through which fluid exits said chamber;
a source for illuminating said chamber with ultraviolet light; and
a plurality of baffles within said chamber for defining a multiplicity of subchambers within said chamber through which fluid to be purified flows from said inlet to said outlet; each subchamber being located to receive the ultraviolet light;
wherein a plurality of holes are defined through at least one said baffle, and wherein said holes collectively define a fluid flow area that increases with the radial distance from the center of said baffle.

2. The fluid disinfection unit of claim 1, wherein the number of said holes increases with the radial distance from the center of said baffle.

3. The fluid disinfection unit of claim 1, wherein the area of said holes decreases with the radial distance from the center of said baffle.

4. The fluid disinfection unit of claim 1, wherein each baffle comprises a disk with at least one central opening defined therethrough, each disk being mounted in said chamber such that said at least one ultraviolet light source extends through said at least one central opening.

5. The fluid disinfection unit of claim 4, further comprising a quartz tube mounted in said chamber such that said quartz tube extends through said at least one central opening, wherein said ultraviolet light source is received within said tube and spaced apart from said tube by a gap;
wherein said gap is a distance greater than the thickness of said quartz tube.

6. The fluid disinfection unit of claim 5, further comprising at least one wiper movable relative to said quartz tube, wherein said motion of said wiper cleans said quartz tube.

7. The fluid disinfection unit of claim 1, wherein at least one said baffle includes a plurality of inner holes defined through said baffle along a first ring radially spaced from the center of said baffle, and a plurality of outer holes defined through said baffle radially spaced from the center of said baffle a distance greater than the radius of said first ring, wherein said inner holes are larger in area than said outer holes.

8. The fluid disinfection unit of claim 7, wherein at least some of said outer holes are defined through said baffle along a second ring radially spaced from the center of said baffle a distance greater than the radius of said first ring.

9. The fluid disinfection unit of claim 1, wherein said outer holes are defined along a plurality of rings centered on the center of said baffle, wherein each said ring is located successively further away from the center of said baffle, and wherein the collective area of the outer holes defined along a particular ring is less than the collective area of the outer holes defined along the next ring located successively outward from the center of said baffle.

10. The fluid disinfection unit of claim 1, wherein at least one said baffle is divisible into an arbitrary number of concentric bands, each having an equal radial dimension, wherein the aggregate hole area within each said band is larger than the aggregate hole area within an adjacent said band closer to the center of said baffle.

11. The fluid disinfection unit of claim 1, wherein the pattern of said holes in said baffle, in combination with the flow rate of water through said chamber, causes circulation of water within at least one subchamber in a cylindrical pattern, where the axis of that cylinder is substantially perpendicular to the axis of said chamber.

12. The fluid disinfection unit of claim 11, wherein said pattern of said holes in said baffle, in combination with the flow rate of water through said chamber, causes circulation of water within at least one subchamber in a cylindrical pattern, wherein the axis of that cylinder is substantially perpendicular to the axis of said chamber, and wherein at least half of the water in that subchamber rotates completely through said cylindrical pattern at least once.

13. The fluid disinfection unit of claim 1, wherein the number of said holes increases generally linearly with the radial distance from the center of said baffle.

14. A fluid disinfection system, comprising:
a plurality of chambers through which fluid can flow, each said chamber having an inlet through which fluid enters said chamber and an outlet through which fluid exits said chamber;
a source for illuminating each said chamber with ultraviolet light; and
a plurality of baffles within each said chamber for defining a multiplicity of subchambers within each said chamber through which fluid to be purified flows from said inlet to said outlet; each subchamber being located to receive the ultraviolet light;
wherein a plurality of holes are defined through at least one said baffle, and wherein the number of said holes increases with the radial distance from the center of said baffle; and
further comprising at least one crossover tube, wherein at least two said chambers are connected in series by at least one said crossover tube, and wherein at least one said crossover tube is located above said chambers connected by said crossover tube.

15. The fluid disinfection system of claim 14, wherein at least four said chambers are connected in two sets of two said chambers each connected in series, and wherein said sets are connected in parallel.

16. The fluid disinfection system of claim 15, further comprising an inlet manifold connected to one end of each set of chambers connected in series, and an outlet manifold connected to the other end of each set of chambers connected in series.

17. The fluid disinfection system of claim 15, further comprising a bypass tube connecting said inlet manifold to said outlet manifold, said bypass tube selectively actuable to receive fluid flow therethrough in lieu of fluid flow through said chambers.

18. The fluid distribution system of claim 14, wherein fluid experiences a pressure drop between substantially 7-10 pounds per square inch as it passes through said chambers.

19. A method for purifying water, comprising:
possessing a system comprising a plurality of chambers through which fluid can flow, each said chamber having an inlet through which fluid enters said chamber and an outlet through which fluid exits said chamber; a source for illuminating each said chamber with ultraviolet light; and a plurality of baffles within each said chamber for defining a multiplicity of subchambers within each said chamber through which fluid to be purified flows from said inlet to said outlet; each subchamber being located to receive the ultraviolet light; wherein a plurality of holes are defined through at least one said baffle; and further comprising at least one crossover tube, wherein at least two said chambers are connected in series by at least one said crossover tube;
passing fluid through said system at a flow rate of up to 100 barrels per minute; and
disinfecting that fluid to a level of >99.9% bacterial kill with said ultraviolet light.

20. The method of claim 19, further comprising maintaining said quartz tube at a temperature within 10° C. of the temperature of the water flowing through at least one said chamber.

21. The method of claim 19, further comprising generating circulation of water within at least one subchamber in a cylindrical pattern, where the axis of that cylinder is substantially perpendicular to the axis of said chamber.
